(19) United States
(12) Patent Application Publication
(10) Pub. No.: US 2011/0016085 A1
(43) Pub. Date: Jan. 20, 2011

(54) METHOD AND SYSTEM FOR MAINTAINING MULTIPLE INODE CONTAINERS IN A STORAGE SERVER

(75) Inventors: Szu-Wen Kuo, Cupertino, CA (US); Sreelatha S. Reddy, Mountain View, CA (US); Jeffrey D. Merrick, Mountain View, CA (US); Amber M. Palekar, Sunnyvale, CA (US)

Correspondence Address: Perkins Coie LLP, P.O. Box 1208, Seattle, WA, 98111-1208, US

(73) Assignee: NetApp, Inc., Sunnyvale, CA (US)

(21) Appl. No.: 12/504,164

(22) Filed: Jul. 16, 2009

(51) Int. Cl. G06F 17/30

(52) U.S. Cl. 707/615; 707/E17.007

(57) ABSTRACT

A system and method for maintaining multiple inode containers is used to manage file system objects in a single logical volume of a network storage server. The system provides multiple inode containers to store metadata for file system objects in the logical volume. The system may use a first inode container to store private inodes used by the storage server and a second inode container to store public inodes that are useable by clients of the storage server. During a replication process, a source storage server generates a set of replication operations based on inodes in the public inode container and excluding inodes in the private inode container. In a destination server implementing multiple inode containers, the server generates inodes based on the replication operations and stores the inodes in the public inode container. These new inodes are stored in the public inode container with the same inode number or identifier as the corresponding inode on the source storage server.

### BACKGROUND

A network storage server is a processing system that is used to store and retrieve data on behalf of one or more hosts (clients) on a network. A storage server operates on behalf of one or more hosts to store and manage data in a set of mass storage devices, such as magnetic or optical storage-based disks or tapes. Some storage servers are designed to service file-level requests from hosts, as is commonly the case with file servers used in a network attached storage (NAS) environment. Other storage servers are designed to service block-level requests from hosts, as with storage servers used in a storage area network (SAN) environment. Still other storage servers are capable of servicing both file-level requests and block-level requests, as is the case with certain storage servers made by NetApp, Inc. of Sunnyvale, Calif.

One common use of storage servers is data replication. Data replication is a technique for backing up data in which a given data set at a source is replicated at a destination that is often geographically remote from the source. The replica data set created at the destination is called a “mirror” of the original data set. Typically replication involves the use of at least two storage servers, e.g., one at the source and another at the destination, which communicate with each other through a computer network or other type of data interconnect.

Each data block in a given unit of data, such as a file in a storage server, can be represented by both a physical block, pointed to by a corresponding physical block pointer, and a logical block pointed to by a corresponding logical block pointer. These two blocks are actually the same data block. However, the physical block pointer indicates the actual physical location of the data block on a storage medium, whereas the logical block pointer indicates the logical position of the data block within the data unit (e.g., a file) relative to other data blocks.

In some replication systems, replication is done at a logical block level. In these systems, the replica at the destination storage server has the identical structure of logical block pointers as the original data set at the source storage server, but may (and typically does) have a different structure of physical block pointers than the original data set at the source storage server. To execute a logical replication, the file system of the source storage server is analyzed to determine changes that have occurred to the file system. The changes are transferred to the destination storage server. This typically includes “walking” the directory trees at the source storage server to determine the changes to various file system objects within each directory tree, as well as identifying the changed file system object's location within the directory tree structure.

A goal of many replication systems is that the replication should be transparent to clients. If a failure occurs in the source storage server, file handles that point to file system objects on the source storage server should be usable to access the corresponding file system object on the destination storage server. By preserving file handles, the replication enables clients to transition easily from the source storage server to the destination storage server.

A further goal is interoperability. In many storage networks, storage server software may be upgraded at different times based on the needs of the network. Thus, replication systems should be able to execute even if the source and destination storage servers use different versions of a storage operating system. At the same time, replication systems should be designed to operate efficiently and without unnecessary extra complexity in achieving these other goals.

### SUMMARY

The present disclosure relates to a system and method for maintaining multiple inode containers in a network storage server. The system uses the multiple inode containers in a single logical volume to store inodes for different types of file system objects. In one embodiment, the system stores inodes for private file system objects (i.e., file system objects used to manage the operation of the storage server) in a first inode container and stores public file system objects (i.e., file system objects that are available to clients of the storage server) in a second inode container. During a replication process, the replication system replicates only file system objects with inodes stored in the public inode container. When the destination storage server receives the replication information, it generates new inodes based on the information and stores the inodes in the public inode container. The new inodes are stored with the same inode numbers as the corresponding inodes on the source storage server.

An advantage of the system is that it allows the storage server to maintain a separation between file system objects that are visible to users and file system objects that are only for internal use by the storage server. By separating the types of files, the system ensures that replicated inodes are able to have the same inode numbers as the corresponding inodes on the source storage server without the risk that the inode numbers will conflict with private inodes that already existed on the destination storage server.

The system has advantages in simplicity over alternate solutions. For example, the system is less complex than a system that maintains a translation table to map the source inode number to a corresponding destination inode. Maintaining multiple inode containers also adds flexibility for future versions of the file system, because it provides additional inodes for private use for any additional private file system objects that are added. In addition, the private inode container can be expanded to accommodate new private inodes without reducing the number of inodes available for public file system objects.

### BRIEF DESCRIPTION OF THE DRAWINGS

FIG. 1 is a network environment in which multiple network storage servers cooperate.

FIG. 2 is an example of the hardware architecture of a storage server.

FIG. 3 is a block diagram of a storage operating system.

FIG. 4 depicts a buffer tree of a file.

FIG. 5 depicts a buffer tree including an inode container.

FIG. 6A illustrates a first method for storing multiple inode containers using the VolumeInfo block.

FIG. 6B illustrates a second method for storing multiple inode containers by storing a reference to the second inode container in the first inode container.

FIG. 7 is a logical block diagram of the multiple inode container system.

FIG. 8 is a flowchart of a process for managing a logical volume on a storage server according to the multiple inode container system.

FIG. 9 is a flowchart of a process for replicating inodes from a source storage server to a destination storage server using the multiple inode container system.

### DETAILED DESCRIPTION

A system and method for maintaining multiple inode containers in a single logical volume of a network storage server is disclosed (hereinafter referred to as “the multiple inode container system” or “the system”). Storage servers maintain a set of inodes for file system objects that store metadata used to manage the operations of the storage server. An “inode” is a metadata container that is used to store metadata about the file, such as ownership, access permissions, file size, file type, and pointers to the highest-level of indirect blocks for the file. A “file system” is an independently managed, self-contained, organized structure of data units (e.g., files, blocks, or logical unit numbers (LUNs)). These inodes are specific to the storage server and are generally hidden from clients of the storage server. During a replication process, problems can occur when these inodes have inode numbers that are identical to inode numbers of inodes from a source storage server. To solve this, the system provides multiple inode containers to store metadata for file system objects in the logical volume. In one embodiment, the system introduced here uses a first inode container to store private inodes used by the storage server. The system then uses a second inode container to store public inodes that are usable by clients of the storage server. The storage server uses a special metadata block called a VolumeInfo block stored in a predefined location to store volume information, such as the name and size of the volume. In one embodiment, the VolumeInfo block stores references pointing to each of the first and second inode containers. In another embodiment, the VolumeInfo block stores a reference to the first inode container and the first inode container stores an inode that references the second inode container.

During a replication process, the source storage server generates a set of replication operations to replicate the source storage server. In general, inodes in the private inode container are considered to be for the source storage server only and are not replicated to the destination storage server. Thus, if the source storage server implements the multiple inode container system, it generates the replication operations based on the inodes in the public inode container and excludes inodes in the private inode container. The replication operations are then transferred to a destination storage server. If the destination storage server implements the multiple inode container system, it generates inodes based on the replication operations and stores the inodes in the public inode container. These new inodes are stored in the public inode container with the same inode number or identifier as the corresponding inode on the source storage server.

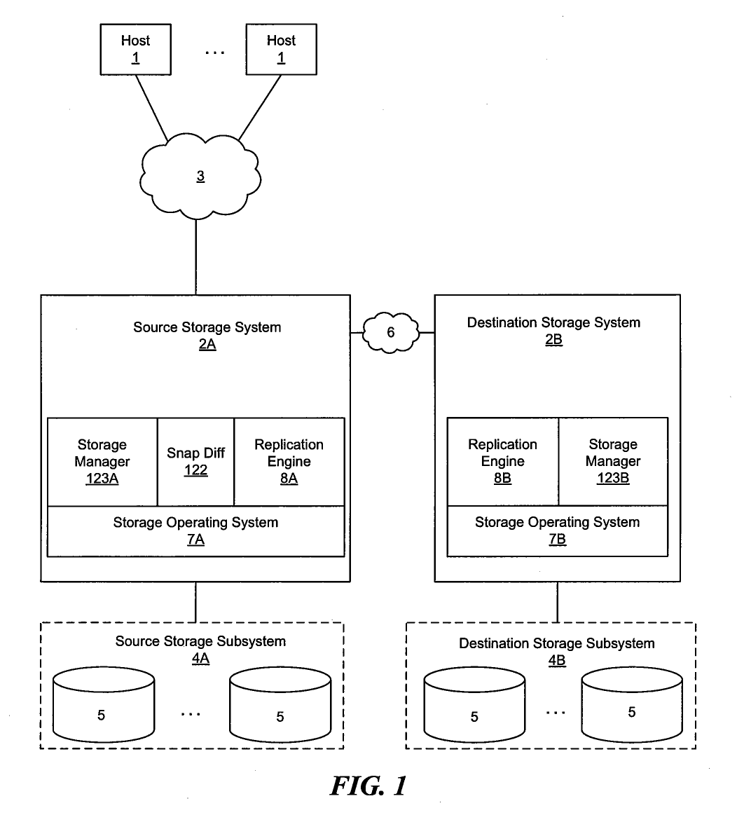

FIG. 1 depicts a configuration of network storage servers in which the techniques being introduced here can be implemented according to an illustrative embodiment. In FIG. 1, a source storage server 2A is coupled to a source storage subsystem 4A and to a set of hosts 1 through an interconnect 3. The interconnect 3 may be, for example, a local area network (LAN), wide area network (WAN), metropolitan area network (MAN), global area network such as the Internet, a Fibre Channel fabric, or any combination of such interconnects. Each of the hosts 1 may be, for example, a conventional personal computer (PC), server-class computer, workstation, handheld computing/communication device, or other computing/communications device.

In one embodiment, source storage server 2A includes a storage operating system 7A, storage manager 123A, snapshot differential module 122, and replication engine 8A. Each of storage operating system 7A, storage manager 123A, snapshot differential module 122, and replication engine 8A are computer hardware components of the storage server, which can be implemented as special purpose hardware circuitry (e.g., “hardwired”), programmable hardware circuitry that is programmed with software and/or firmware, or any combination thereof. Storage of data in the source storage subsystem 4A is managed by storage manager 123A of source storage server 2A. Source storage server 2A and source storage subsystem 4A are collectively referred to as a source storage server. The storage manager 123A receives and responds to various read and write requests from the hosts 1, directed to data stored in or to be stored in storage subsystem 4A. Storage subsystem 4A includes a number of nonvolatile mass storage devices 5, which can be, for example, magnetic disks, optical disks, tape drives, solid-state memory, such as flash memory, or any combination of such devices. The mass storage devices 5 in storage subsystem 4A can be organized as a RAID group, in which case the storage controller 2 can access the storage subsystem 4 using a conventional RAID algorithm for redundancy.

Storage manager 123A processes write requests from hosts 1 and stores data to unused storage locations in mass storage devices 5 of the storage subsystem 4A. In one embodiment, the storage manager 123A implements a “write anywhere” file system such as the proprietary Write Anywhere File Layout (WAFL™) file system developed by NetApp, Inc. Such a file system is not constrained to write any particular data or metadata to any particular storage location or region. Rather, such a file system can write to any unallocated block on any available mass storage device and does not overwrite data on the devices. If a data block on disk is updated or modified with new data, the data block is thereafter stored (written) to a new location on disk instead of modifying the block in place to optimize write performance.

The storage manager 123A of source storage server 2A is responsible for managing storage of data in the source storage subsystem 4A, servicing requests from hosts 1, and performing various other types of storage related operations. In one embodiment, the storage manager 123A, the source replication engine 8A and the snapshot differential module 122 are logically on top of the storage operating system 7A. In other embodiments, the components may be logically separate from the storage operating system 7A and may interact with the storage operating system 7A on a peer-to-peer basis. The source replication engine 8A operates in cooperation with a remote destination replication engine 8B, described below, to perform logical replication of data stored in the source storage subsystem 4A. Note that in other embodiments, one or more of the storage manager 123A, replication engine 8A and the snapshot differential module 122 may be implemented as elements within the storage operating system 7A.

The source storage server 2A is connected to a destination storage server 2B through an interconnect 6, for purposes of replicating data. Although illustrated as a direct connection, the interconnect 6 may include one or more intervening devices and/or may include one or more networks. In the illustrated embodiment, the destination storage server 2B includes a storage operating system 7B, replication engine 8B and a storage manager 123B. The storage manager 123B controls storage related operations on the destination storage server 2B. In one embodiment, the storage manager 123B and the destination replication engine 8B are logically on top of the storage operating system 7B. In other embodiments, the storage manager 123B and the destination replication engine 8B may be implemented as elements within storage operating system 7B. The destination storage server 2B and the destination storage subsystem 4B are collectively referred to as the destination storage server.

The destination replication engine 8B works in cooperation with the source replication engine 8A to replicate data from the source storage server to the destination storage server. In certain embodiments, the storage operating systems 7A and 7B, replication engines 8A and 8B, storage managers 123A and 123B, and snapshot differential module 122 are all implemented in the form of software. In other embodiments, however, any one or more of these elements may be implemented in hardware alone (e.g., specially-designed dedicated circuitry), firmware, or any combination of hardware, software and firmware.

Storage servers 2A and 2B each may be, for example, a storage server which provides file-level data access services to hosts 1, such as commonly done in a NAS environment, or block-level data access services such as commonly done in a SAN environment, or they may be capable of providing both file-level and block-level data access services to hosts 1. Further, although the storage servers 2 are illustrated as monolithic systems in FIG. 1, they can have a distributed architecture. For example, the storage servers 2 each can be designed as physically separate network modules (e.g., “N-module”) and data modules (e.g., “D-module”) (not shown), which communicate with each other over a physical interconnect. Such an architecture allows convenient scaling, such as by deploying two or more N-modules and D-modules, all capable of communicating with each other over the interconnect.

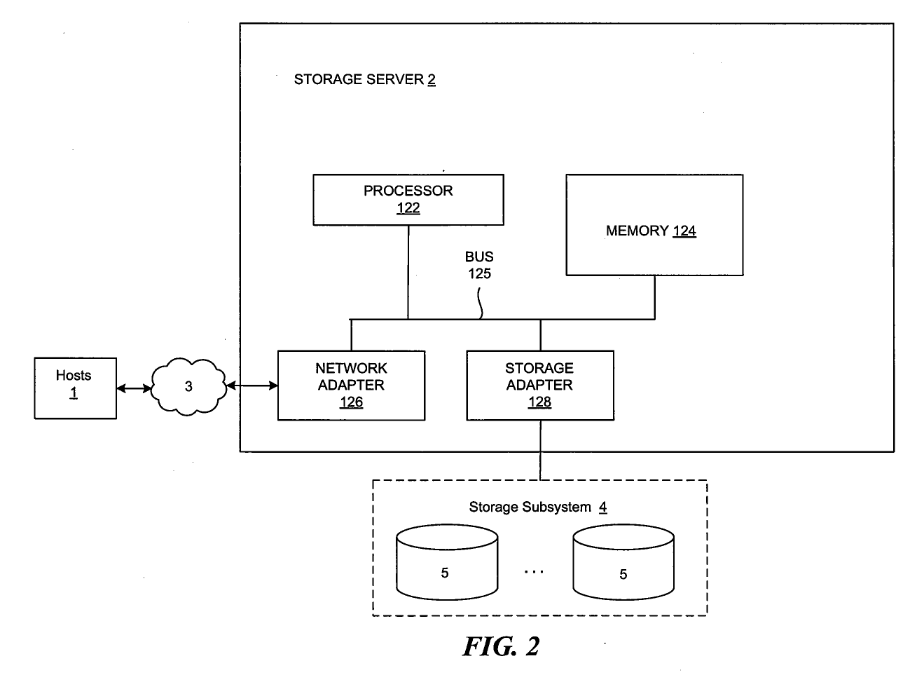

FIG. 2 is a high-level block diagram of an illustrative embodiment of a storage server 2. The storage server 2 includes one or more processors 122 and memory 124 coupled to an interconnect bus 125. The interconnect bus 125 shown in FIG. 2 is an abstraction that represents any one or more separate physical interconnect buses, point-to-point connections, or both, connected by appropriate bridges, adapters, and/or controllers. The interconnect bus 125, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The processor(s) 122 is/are the central processing unit(s) (CPU) of the storage servers 2 and, therefore, control the overall operation of the storage servers 2. In certain embodiments, the processor(s) 122 accomplish this by executing software or firmware stored in memory 124. The processor(s) 122 may be, or may include, one or more programmable general-purpose or special-purpose microprocessors, digital signal processors (DSPs), programmable controllers, application specific integrated circuits (ASICs), programmable logic devices (PLDs), trusted platform modules (TPMs), or the like, or a combination of such devices. The memory 124 is or includes the main memory of the storage servers 2.

The memory 124 represents any form of random access memory (RAM), read-only memory (ROM), flash memory, or the like, or any combination of such devices. Also connected to the processor(s) 122 through the interconnect bus 125 is a network adapter 126 and a storage adapter 128. The network adapter 126 provides the storage servers 2 with the ability to communicate with remote devices, such as hosts 1, over the interconnect 3 of FIG. 1, and may be, for example, an Ethernet adapter or Fibre Channel adapter. The storage adapter 126 allows the storage servers 2 to access storage subsystems 4A or 4B, and may be, for example, a Fibre Channel adapter or SCSI adapter.

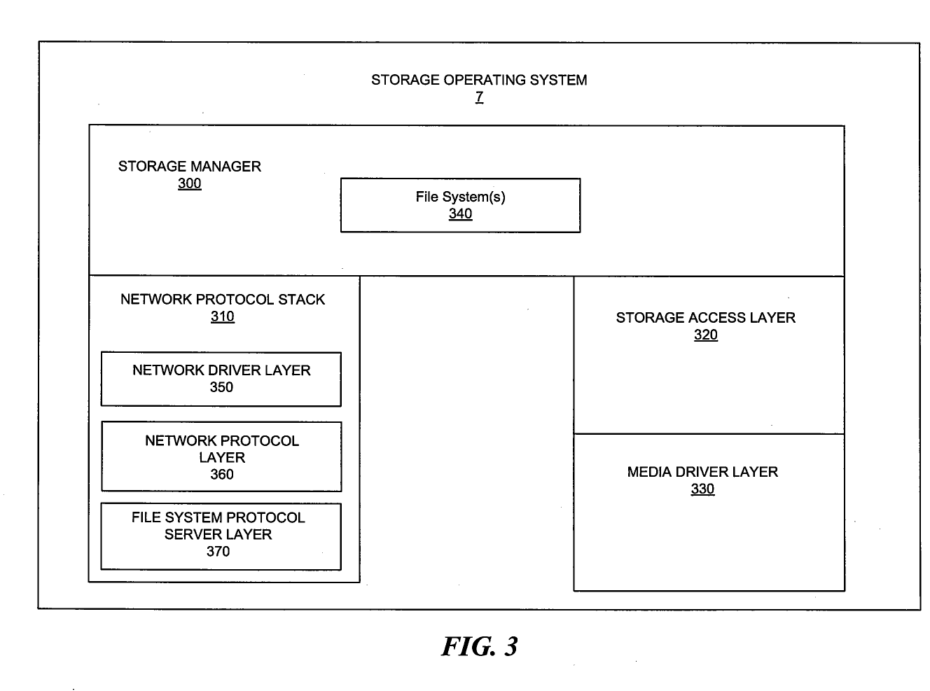

FIG. 3 is a block diagram of a storage operating system according to an illustrative embodiment. As used herein, the term “storage operating system” generally refers to the computer-executable code operable on a computer to perform a storage function that manages data access and other related functions. Storage operating system 7 can be implemented as a microkernel, an application program operating over a general-purpose operating system such as UNIX® or Windows NT®, or as a general-purpose operating system configured for the storage applications as described herein. In the illustrated embodiment, the storage operating system includes a network protocol stack 310 having a series of software layers including a network driver layer 350 (e.g., an Ethernet driver), a network protocol layer 360 (e.g., an Internet Protocol layer and its supporting transport mechanisms: the TCP layer and the User Datagram Protocol layer), and a file system protocol server layer 370 (e.g., a CIFS server, a NFS server, etc.). In addition, the storage operating system 7 includes a storage access layer 320 that implements a storage media protocol such as a RAID protocol, and a media driver layer 330 that implements a storage media access protocol such as, for example, a Small Computer Systems Interface (SCSI) protocol. Any and all of the modules of FIG. 3 can be implemented as a separate hardware component. For example, the storage access layer 320 may alternatively be implemented as a parity protection RAID module and embodied as a separate hardware component such as a RAID controller. Bridging the storage media software layers with the network and file system protocol layers is the storage manager 123 that implements one or more file system(s) 340. For the purposes of this disclosure, a file system is a structured (e.g., hierarchical) set of stored files, directories and/or other data containers. In one embodiment, the storage manager 123 implements data layout algorithms that improve read and write performance to the mass storage media 5, such as WAFL systems discussed above.

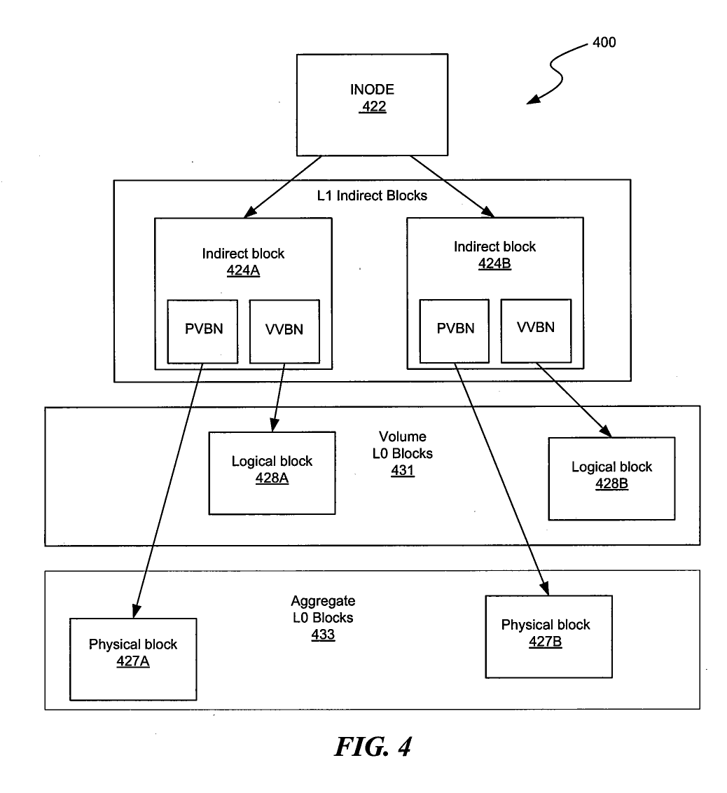

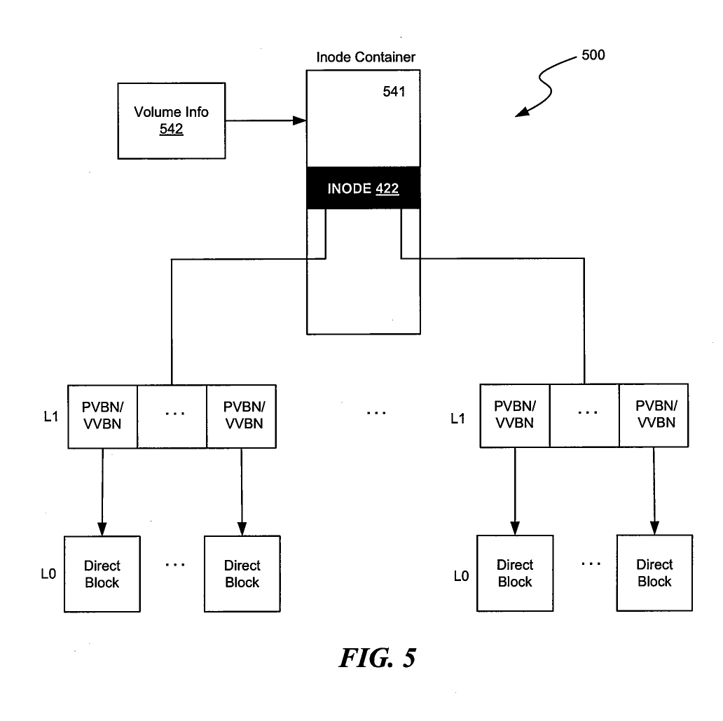

It is useful now to consider how data can be structured and organized by storage servers 2A and 2B in certain embodiments. Reference is now made to FIGS. 4 and 5 in this regard. In at least one embodiment, data is stored in the form of volumes, where each volume contains one or more directories, subdirectories, and/or files. The term “aggregate” is used to refer to a pool of physical storage, which combines one or more physical mass storage devices (e.g., disks) or parts thereof, into a single storage object. An aggregate also contains or provides storage for one or more other data sets at a higher-level of abstraction, such as volumes. A “volume” is a set of stored data associated with a collection of mass storage devices, such as disks, which obtains its storage from (i.e., is contained within) an aggregate, and which is managed as an independent administrative unit, such as a complete file system. A volume includes one or more file systems, such as an active file system and, optionally, one or more persistent point-in-time images of the active file system captured at various instances in time. As stated above, a “file system” is an independently managed, self-contained, organized structure of data units (e.g., files, blocks, or logical unit numbers (LUNs)). Although a volume or file system (as those terms are used herein) may store data in the form of files, that is not necessarily the case. That is, a volume or file system may store data in the form of other units of data, such as blocks or LUNs.

In certain embodiments, each aggregate uses a physical volume block number (PVBN) space that defines the physical storage space of blocks provided by the storage devices of the physical volume, and likewise, each volume uses a virtual volume block number (WBN) space to organize those blocks into one or more higher-level objects, such as directories, subdirectories, and files. A PVBN, therefore, is an address of a physical block in the aggregate and a WBN is an address of a block in a volume (the same block as referenced by the corresponding PVBN), i.e., the offset of the block within the volume. The storage manager 300 tracks information for all of the VVBNs and PVBNs in each storage server 2. Each WBN space is an independent set of values that corresponds to locations within a directory or file, which are translated to device block numbers (DBNs) on the physical storage device. The storage manager 300 may manage multiple volumes on a common set of physical storage in the aggregate.

In addition, data within the storage server is managed at a logical block level. At the logical block level, the storage manager maintains a logical block number (LBN) for each data block. If the storage server stores data in the form of files, the LBNs are called file block numbers (FBNs). Each FBN indicates the logical position of the block within a file, relative to other blocks in the file, i.e., the offset of the block within the file. For example, FBN 0 represents the first logical block in a particular file, while FBN 1 represents the second logical block in the file, and so forth. Note that the PVBN and VVBN of a data block are independent of the FBN(s) that refer to that block. In one embodiment, the FBN of a block of data at the logical block level is assigned to a PVBN-WBN pair.

In certain embodiments, each file is represented in the storage server in the form of a hierarchical structure called a “buffer tree.” As used herein, the term buffer tree is defined as a hierarchical metadata structure containing references (or pointers) to logic blocks of data in the file system. A buffer tree is a hierarchical structure which used to store file data as well as metadata about a file, including pointers for use in locating the data blocks for the file. A buffer tree includes one or more levels of indirect blocks (called “L1 blocks”, “L2 blocks”, etc.), each of which contains one or more pointers to lower-level indirect blocks and/or to the direct blocks (called “L0 blocks”) of the file. All of the data in the file is stored only at the lowest level (L0) blocks. The root of a buffer tree is stored in the “inode” of the file. As noted above, an inode is a metadata container that is used to store metadata about the file, such as ownership, access permissions, file size, file type, and pointers to the highest-level of indirect blocks for the file. Each file has its own inode. The inode is stored in a separate inode container, which may itself be structured as a buffer tree. The inode container may be, for example, an inode file. In hierarchical (or nested) directory file systems, this essentially results in buffer trees within buffer trees, where subdirectories are nested within higher-level directories and entries of the directories point to files, which also have their own buffer trees of indirect and direct blocks. Directory entries include the name of a file in the file system, and directories are said to point to (reference) that file. Alternatively, a directory entry can point to another directory in the file system. In such a case, the directory with the entry is said to be the “parent directory,” while the directory that is referenced by the directory entry is said to be the “child directory” or “subdirectory.”

FIG. 4 depicts a buffer tree of a file according to an illustrative embodiment. In the illustrated embodiment, a file is assigned an inode 422, which references Level 1 (L1) indirect blocks 424A and 424B. Each indirect block 424 stores at least one PVBN and a corresponding WBN for each PVBN. There is a one-to-one mapping between each WBN and PVBN. Note that a PVBN is a block number in an aggregate (i.e., offset from the beginning of the storage locations in an aggregate) and a WBN is a block number in a volume (offset from the beginning of the storage locations in a volume); however, there is only one copy of the L0 data block physically stored in the physical mass storage of the storage server. Also, to simplify description, only one PVBN-WBN pair is shown in each indirect block 424 in FIG. 4; however, an actual implementation would likely include multiple/many PVBN-VVBN pairs in each indirect block 424. Each PVBN references a physical block 427A and 427B, respectively, in the storage device (i.e., in the aggregate L0 blocks 433) and the corresponding WBN references a virtual volume block 428A and 428B, respectively, in the storage device (i.e., in the volume L0 blocks 431). In addition, volumes can also be represented by files called “container files.” In such a case, the WBN references a block number offset from the beginning of the container file representing the volume. Physical blocks 427 and volume blocks 428 are actually the same L0 data for any particular PVBN-WBN pair; however, they are accessed in different ways: the PVBN is accessed directly in the aggregate 30, while the WBN is accessed virtually via the container file representing the volume.

FIG. 5 depicts a buffer tree including an inode container. In FIG. 5, for each volume managed by the storage server 2, the inodes of the files and directories in that volume are stored in an inode container 541. A separate inode container 541 is maintained for each volume. An inode container 541, in one embodiment, is a data structure representing a master list of file system objects (e.g., directories, subdirectories and files) of the file system in the storage server and each inode entry identifies a particular file system object within the file system. Each inode 422 in the inode container 541 contains the root of a buffer tree 400 of the file corresponding to the inode 422. The location of the inode container 541 for each volume is stored in a VolumeInfo block 542 associated with that volume. The VolumeInfo block 542 is a metadata container that contains metadata that applies to the volume as a whole. Examples of such metadata include, for example, the volume's name, type, size, any space guarantees to apply to the volume, and the WBN of the inode container of the volume. In general, the VolumeInfo block 542 is stored in a known location on the storage server, so that the storage server can always retrieve its metadata.

File system objects can be, for example, files, directories, sub-directories, and/or LUNs of the file system. File system object inodes are arranged sequentially in the inode container, and a file system object's position in the inode container is given by its inode number or inode identifier. For directory entries, each entry includes the names of the files the directory entry references and the files' inode numbers. In addition, a directory has its own inode and inode number. An inode includes a master location catalog for the file, directory, or other file system object and various bits of information about the file system object called metadata. The metadata includes, for example, the file system object's creation date, security information such as the file system object's owner and/or protection levels, and its size. The metadata also includes a “type” designation to identify whether the file system object is one of the following types: 1) a “file;” 2) a “directory;” or 3) “unused.”

The metadata also includes the “generation number” of the file system object. As time goes by, file system objects are created or deleted, and slots in the inode file are recycled. When a file system object is created, its inode is given a new generation number, which is guaranteed to be different from (e.g., larger than) the previous file system object at that inode number (if any). If repeated accesses are made to the file system object by its inode number (e.g., from clients, applications, etc.), the generation number can be checked to avoid inadvertently accessing a different file system object after the original file system object was deleted. The metadata also includes “parent information,” which is the inode number of the file system object's parent directory. A file system object can have multiple parent directories.

Storage servers maintain a set of inodes for file system objects that store metadata used to manage the operations of the storage server. These inodes are referred to as “private” inodes because they refer to file system objects that are generally not visible to clients of the storage server (in contrast to “public” inodes that are visible to clients). These objects store metadata for controlling aspects of the physical device and the logical volume, such as tracking which data blocks in a volume or aggregate are available for use. Much of the metadata relates only to the private state of the particular device. The inodes for these objects are often generated when the storage server first starts, but may also be generated in response to a system reconfiguration (e.g., activating a new feature such as encryption). These file system objects may also include application metadata (i.e., hidden metafiles created by the storage server on behalf of an application).

For various reasons, it may be desirable to maintain a replica of a data set in the source storage server. For example, in the event of a power failure or other type of failure, data lost at the source storage server can be recovered from the replica stored in the destination storage server. In at least one embodiment, the data set is a file system of the storage server and replication is performed using snapshots. A “snapshot” is a persistent image (usually read-only) of the file system at a point in time and can be generated by the source snapshot differential module 122. At a point in time, the differential source module 122 generates a first snapshot of the file system of the source storage server, referred to as the baseline snapshot. This baseline snapshot is then provided to the source replication engine 8A for replication operations. Subsequently, the source differential module 122 generates additional snapshots of the file system from time to time.

At some later time, the source replication engine 8A executes another replication operation (which may be at the request of the destination replication engine 8B). To do so, the source replication engine 8A needs to be updated with the changes to the file system of the source storage server since a previous replication operation was performed. The snapshot differential module 122 compares the most recent snapshot of the file system of the source storage server to the snapshot of a previous replication operation to determine differences between a recent snapshot and the previous snapshot. The snapshot differential module 122 identifies any data that has been added or modified since the previous snapshot operation, and sends those additions or modifications to the source replication engine 8A for replication. The source replication engine 8A then generates change messages for each of the additions or modifications. The change messages include information defining a file system operation that will be executed on the destination storage server 2B to replicate the changes to the source system following the previous replication. The change messages are then transmitted to the destination replication engine 8B for execution on the destination storage server 2B.

A replication operation transfers information about a set of file system operations from a source file system to the replica destination file system. In one embodiment, a file system operation includes data operations, directory operations, and inode operations. A “data operation” transfers 1) a block of file data, 2) the inode number of the block of data, 3) the generation number of the file, and 4) the position of the block within the file (e.g., FBN). A “directory operation” transfers 1) the inode number of the directory, 2) the generation number of the directory, and 3) enough information to reconstitute an entry in that directory including: 1) the name; 2) inode number; and 3) generation number of the file system object the directory entry points to. Finally, an “inode operation” transfers 1) the meta-data of an inode and 2) its inode number. To perform a replication of an entire file system, the source storage server sends a sequence of data operations, directory operations, and inode operations to the destination, which is expected to process the operations and send acknowledgments to the source. As used herein, the inode number (or numbers) in each file system operation is referred to as the “target inode number”.

A replication of a file system may be either an “initialization”, in which the destination file system starts from scratch with no files or directories, or it may be an “update”, in which the destination file system already has some files and directories from an earlier replication operation of an earlier version of the source. In an update, the source file system does not need to send every file and directory to the destination; rather, it sends only the changes that have taken place since the earlier version was replicated. Inode operations have various types, including delete (where the file system object associated with the inode number is deleted), create (where a new file system object is created at the target inode number), and modify (where the contents or metadata of the file system object are modified).

During the replication process, the destination storage server executes each of the replication operations. In some systems, the destination storage server generates each new inode to have an inode number identical to the inode number of the corresponding inode on the source storage server. Maintaining the same inode number allows clients of the destination storage server to use file handles that were used for files on the source storage server to interact with the corresponding inodes on the destination storage server. This is more efficient than invalidating the file handles or requiring the destination storage server to maintain a mapping from the original file handle to the corresponding inode.

However, a problem occurs when the destination storage server receives a replication operation directing it to create an inode with an inode number that is already used by a private inode. This can occur because many of the private inodes are generated on the destination storage server before the replication process is initiated. One possible solution to this problem is for the destination storage server to relocate a conflicting private inode to a new inode number in response to the conflict. However, this imposes additional processing for the replication process. In addition, the private inode might need to be relocated again if the new inode number conflicts with another replication operation. Alternatively, the destination storage server could define a specific range of inode numbers that are specifically for storing private inodes. However, this solution is not scalable, because the number of private inodes that can be created by the system are limited by the size of the range.

To avoid these problems, the system provides multiple inode containers to store the different types of inodes. These inode containers could be implemented as, for example, a set of files stored in a file system of a logical volume. In one embodiment, the system uses two inode containers to store the data: a first inode container that stores the private inodes (the “private inode container”) and a second inode container that stores public inodes (the “public inode container”). In this embodiment, file system objects referenced by inodes in the private inode container are hidden from clients of the storage server, while file system objects referenced by inodes in the public inode container are generally visible to clients. In some embodiments, inodes are automatically assigned to a particular inode container based on various factors, such as the entity that created the inode (e.g., the operating system or a client) or the type of file system object represented by the inode (e.g., by assigning metafiles to the private inode container). In other implementations, the assignment is determined in advance by a designer specifying that particular inodes should be placed in the private inode container. In another embodiment, the system provides more than two inode containers. For example, the storage server can be configured to support multiple inode sizes in order to optimize space consumption. The system could then use multiple inode containers to store inodes based on the size of the structure.

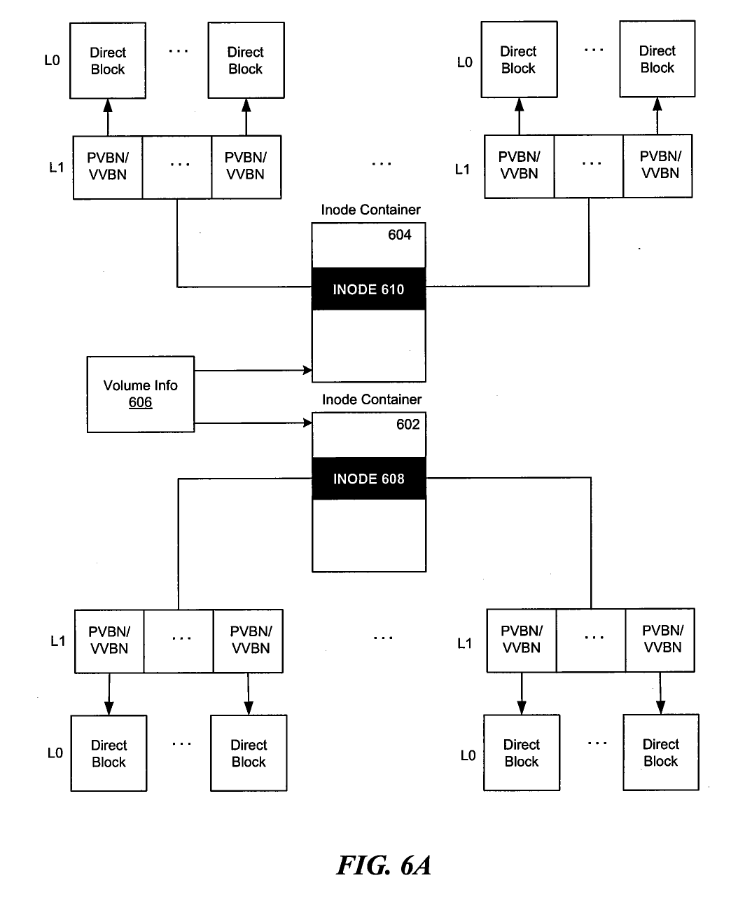

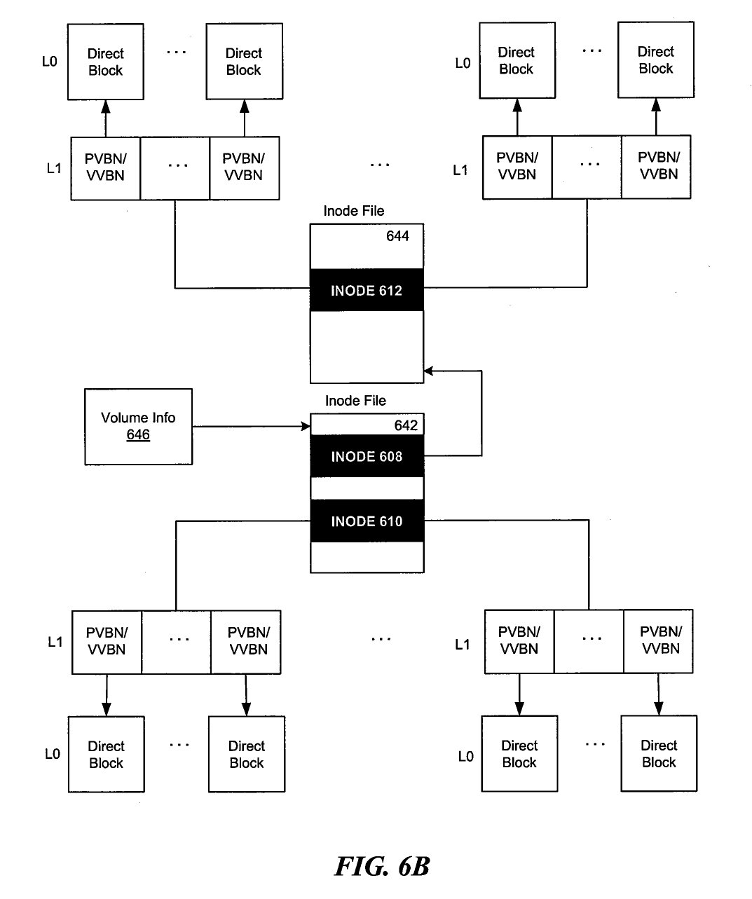

FIGS. 6A and 6B illustrate two methods for storing the multiple inode containers. FIG. 6A illustrates a first method for storing multiple inode containers using the VolumeInfo block. As discussed above for FIG. 5, the VolumeInfo block 606 is a metadata container that contains metadata that applies to the volume as a whole, such as the volume's name, type, size, etc. As shown in FIG. 5, the VolumeInfo block 542 also stores a reference (e.g., the VVBN) to the inode container. In the method shown in FIG. 6A, the VolumeInfo block 606 is expanded to include references to both of the storage server's inode containers 602 and 604. As with the configuration shown in FIG. 5, the first inode container 602 includes an inode 608 and the second inode container 604 includes an inode 610. Each of the inodes 608 and 610 includes indirect blocks L1 and direct blocks L0 that are configured as described above in FIGS. 4 and 5. Although the figure shows that the VolumeInfo block 606 includes references to two inode containers 602 and 604, the system may support additional inode containers by storing references to the additional inode containers in the VolumeInfo block 606.

FIG. 6B illustrates a second method for storing multiple inode containers by storing a reference to the second inode container in the first inode container. As with the first method, the method shown in FIG. 6B includes a VolumeInfo block 646. However, the VolumeInfo block 646 includes only a single reference to a first inode container 642. Thus, the VolumeInfo block 646 does not need to be modified from the structure shown in FIG. 5 for a single inode system. The first inode container 642 includes a first inode 608 and a second inode 610. The second inode 610 is a standard file system inode and points to the blocks of a standard file system object, such as a file or directory. However, the first inode 608 is a special inode that points to the location of the second inode container 644. For simplicity, the inode 608 is generally stored at a predefined inode number in the inode container 642. In the configuration shown in FIG. 6B, the first inode container 642 is generally the private inode container, while the second inode container 644 is generally the public inode container.

An advantage of the configuration shown in FIG. 6B is that it is extensible. That is, if the system includes three inode containers, the first inode container 642 contains inodes pointing to the second and to the third inode containers. This method could therefore be used to extend the multiple inode container system to provide an arbitrary number of inode containers. In contrast, the first method of FIG. 6A is limited by the size of the VolumeInfo block 606. However, the configuration of FIG. 6B imposes additional complexity, because the file system must often navigate multiple levels of inode containers to find a particular inode. In contrast, in FIG. 6A the file system can directly access each of the inode containers through the VolumeInfo block 606.

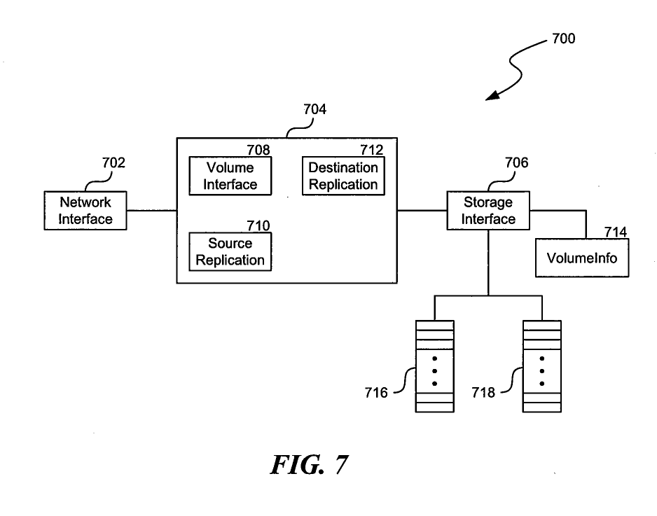

FIG. 7 is a logical block diagram of the multiple inode container system 700. The system 700 can be implemented on any storage server 2, such as the source storage server 2A or the destination storage server 2B (FIG. 1). Aspects of the system may be implemented as special purpose hardware circuitry, programmable circuitry, or a combination of these. As will be discussed in additional detail herein, the system 700 includes a number of modules to facilitate the functions of the system. Although the various modules are described as residing in a single server, the modules are not necessarily physically collocated. In some embodiments, the various modules could be distributed over multiple physical devices and the functionality implemented by the modules may be provided by calls to remote services. Similarly, the data structures could be stored in local storage or remote storage, and distributed in one or more physical devices. Assuming a programmable implementation, the code to support the functionality of this system may be stored on a computer-readable medium such as an optical drive, flash memory, or a hard drive. One skilled in the art will appreciate that at least some of these individual components and subcomponents may be implemented using application specific integrated circuits (ASICs), programmable logic devices (PLDs), or a general purpose processor configured with software and/or firmware.

As shown in FIG. 7, the system 700 includes a network interface 702, which is configured to transmit or receive data through a network, such as the interconnect 3 or the interconnect 6 of FIG. 1. The network interface 702 is used to receive requests from clients 1 and to transmit responses to those requests. The network interface 702 is also used to transmit or receive replication operations during a replication process.

Similarly, the system 700 includes a storage interface 706, which is configured to interact with one or more storage components in a storage subsystem. These may be, for example, the storage devices 5 in the storage subsystem 4 shown in FIG. 2. In particular, the storage interface 706 provides the system 700 with access to the VolumeInfo block 714. As discussed above, the VolumeInfo block 714 is stored in a predefined location in the storage server so the system 700 can use its information to determine other parameters of the storage server. In particular, the VolumeInfo block 714 includes references to one or more of the inode containers in the storage server. The storage interface 706 also provides access to inode containers 716 and 718, which may be used as a public inode container and a private inode container.

The public inode container stores a root inode, which represents the highest level of a hierarchical file system. In some embodiments, the root inode is a root directory that represents the highest level of a directory-based file system hierarchy. In some systems, the root inode is stored at an inode number that is predefined by the storage operating system. However, in some cases, the system 700 may be used to replicate data from a storage server that uses a different operating system from the operating system of the destination storage server (e.g., the source storage server uses the Linux operating system while the destination storage server uses the WAFL file system). In these cases, the source storage server may store the root inode at a different location than the destination storage server's predefined location. To handle this, the system 700 communicates with the source storage server to determine a new location for the root inode. The system then stores the location of the root inode in a known data structure, such as the VolumeInfo block 714. The root inode is visible to clients and is stored in the public inode container.

The system 700 also includes a processing component 704, which is configured to manage access to the inode containers 716 and 718 and to manage the replication process using the multiple inode containers. The processing component 704 could be implemented, for example, by the processor 122 of FIG. 2.

The processing component 704 includes a volume interface component 708, which is configured to manage interaction with a logical volume on a storage server. The volume interface component 708 encapsulates the functionality required to enable access to the inodes on the logical volume and therefore logically includes a broad set of components of the storage operating system 7, including the storage manager 300. In particular, the volume interface component 708 accesses the information in the VolumeInfo block 714 and the inode containers 716 and 718 to determine the locations of file system objects in response to client requests or storage management requirements.

The processing component 704 also includes a source replication component 710, which is configured to generate a set of replication operations from the storage server. The source replication component 710 executes when the storage server is acting as a source storage server 2A. As discussed above, in a storage server with two inode containers, the system 700 may use the first inode container 716 as a private inode container and the second inode container 718 as a public inode container. In this embodiment, the source replication component 710 generates a set of replication operations to mirror the inodes in the public inode container (i.e., second inode container 718) but not the inodes in the private inode container 716. This is practical because the inodes in the private inode container are only necessary for internal use by the source storage server. The set of replication operations can be provided to the destination storage server regardless of whether the destination supports a single inode container or multiple inode containers.

Similarly, the processing component 704 includes a destination replication component 712, which is configured to execute a set of replication operations received from a source storage server. In a system with a private inode container and a public inode container, the destination replication component 712 stores all new inodes in the public inode container, because the private inode container is reserved for internal use on the destination system. Thus, the destination replication component 712 can generate new inodes for storage in the public inode container 718 without having to determine whether the new inodes have the same inode numbers as the storage server's private inodes.

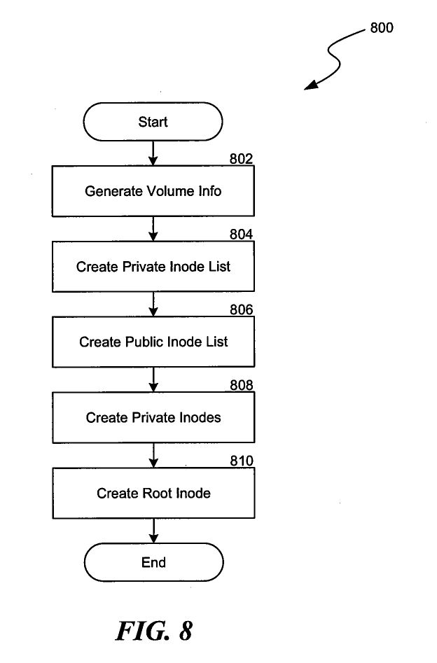

FIG. 8 is a flowchart of a process 800 for managing a logical volume on a storage server according to the multiple inode container system. The steps of the process 800 are executed by the volume interface component 708. One skilled in the art will appreciate that the system files may be created in an order different from the order shown in FIG. 8. Processing begins at step 802, where the system generates a VolumeInfo block for a particular logical volume. In this step, the system determines the relevant information for the volume (e.g., name, size, etc.) and stores the VolumeInfo block in a location on the storage server.

Processing then proceeds to step 804, where the system creates a private inode container for the logical volume. After creating the private inode container, the system stores the private inode container in the logical volume and stores a reference to the private inode container in the VolumeInfo block. The system then executes similar steps in step 806 to create the public inode container in step 806. As discussed above, after storing the public inode container on the logical volume, the system stores a reference to the public inode container in the VolumeInfo block or in the private inode container, depending on which of the methods disclosed in FIGS. 6A and 6B will be used to manage the multiple inode containers.

The system then proceeds to step 808, where it generates private inodes for the storage server. As discussed above, these inodes are generally created at the time that the volume is created, although additional private inodes may be created during later operation. The system then stores the private inodes in the private inode container. In some embodiments, the private inodes are assigned inode numbers according to a predetermined mapping. An advantage of this is that the storage server does not have to maintain a lookup data structure to track the locations of these private inodes. In other embodiments, the private inodes are assigned inode numbers in an arbitrary order as each new inode is created.

The system then proceeds to step 810, where it creates the root inode for the file system on the logical volume. As discussed above, the root inode is a container inode (e.g., a directory inode) that serves as the highest level of the file system hierarchy on the logical volume. The root inode can be stored in the public inode container at a predetermined inode number. In one embodiment, the inode number for the root inode is determined at design time and is the same for all storage servers implementing a particular version of the storage operating system. In another implementation, the root inode is initially stored at the predetermined location, but the location may be modified when a mirroring relationship is established. In particular, if the source storage server uses a different operating system from the destination storage device, establishing the mirroring relationship may include negotiating between the source storage server and the destination storage server to establish a location for the root inode. A reference to the new location may be stored in the VolumeInfo block.

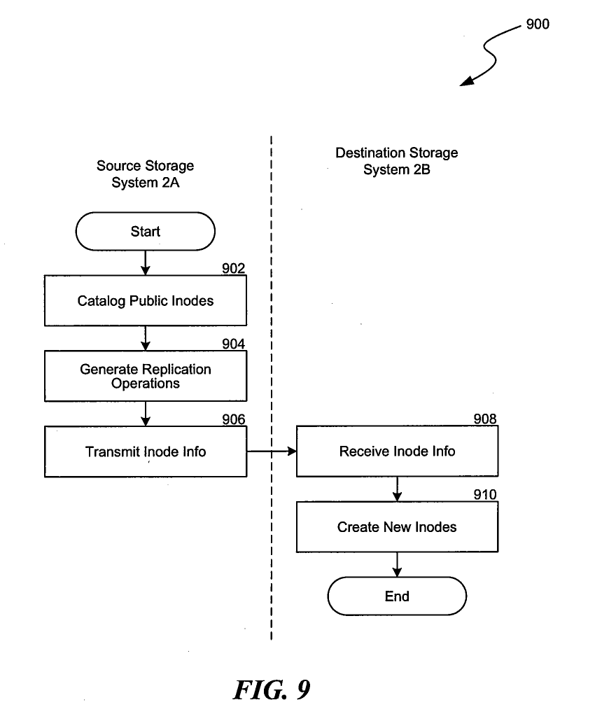

FIG. 9 is a flowchart of a process 900 for replicating inodes from a source storage server 2A to a destination storage server 2B using the multiple inode container system. The process 900 may be used to replicate inodes from the source storage server to the destination storage server even if only one of the storage servers implements the multiple inode container system.

Processing begins at step 902, where the source replication component 710 catalogs public inodes on the storage server. If the source storage server implements the multiple inode container system, this step can be executed by determining a list of all inodes stored in the public inode container. In a single inode container system, the step 902 includes determining a subset of inodes to be replicated based on all of the inodes in the single inode container. Note that although the discussion of FIG. 9 focuses on inode creation operations, other types of operations may also be transmitted as a part of the mirroring relationship. However, these other operations delete or modify existing inodes and are therefore not directly related to the purpose of using multiple inode containers.

After cataloging the public inodes, processing proceeds to step 904, where the source replication engine 8A (FIG. 1) generates replication operations based on the public inodes in the source storage server. As discussed above, each replication operation includes information specifying the type of operation and defining metadata related to the operation, such as the target inode number. After generating the replication operations, the system proceeds to step 906, where the source storage server 2A transmits the replication operations to the destination storage server 2B through an interconnect.

At step 908, the destination replication engine 8B receives the generated replication operations. Processing then proceeds to step 910, where the destination replication component 712 creates new inodes (or otherwise modifies the destination storage server 2B) based on the received replication operations. If the destination storage server 2B does not implement the multiple inode container system, the storage server generates new inodes according to current technology. If the destination storage server 2B implements the multiple inode container system, the system generates new inodes based on the replication operations and stores the inodes in the public inode container on the destination storage server.

A similar process may be used to upgrade the operating system of a storage server to a software version that supports multiple inode containers. During upgrade, the system catalogs each inode from the initial system to determine whether the inode should be placed in the public inode container or the private inode container. In one embodiment, the system determines a first set of inodes that are to be placed in the private inode container (i.e., inodes of file system objects used for system management) and assigns the remaining inodes to the public inode container. During the upgrade, the system creates the public and private inode containers and relocates each set of inodes to the corresponding inode container. The public inodes can be assigned the same inode number as they had in the initial system, while the private inodes can be assigned inode numbers using any desired method, such as a pre-determined mapping. If the operating system is later reverted to the prior operating system version (i.e., a single inode container system), the system simply relocates inodes from the public inode container to the same inode number in the single inode container. The system then relocates inodes from the private inode container to the single inode container by storing the inodes in locations not used by the public inodes.

From the above, it will be appreciated that specific embodiments of the invention have been described herein for purposes of illustration, but that various modifications may be made without deviating from the spirit and scope of the invention. Accordingly, the invention is not limited except as by the appended claims.

I/We claim:

1. A method for replicating metadata in a network storage server, the method comprising:
generating a private metadata file associated with a file system of the network storage server;
generating a public metadata file associated with the file system;
storing a first metadata container associated with a first file system object in the private metadata file, wherein the first file system object is a system file associated with the file system;
receiving an instruction to perform a replication operation from a source storage server;
generating a second file system object in the file system of the network storage server based on the instruction; and
storing a second metadata container associated with the generated file system object in the public metadata file.

2. The method of claim 1, wherein the instruction to perform the replication operation includes a target metadata container identifier and the second metadata container is assigned the target metadata container identifier in the file system of the network storage server.

3. The method of claim 1, wherein the private metadata file includes a plurality of private file system objects and the public metadata file includes a plurality of public file system objects, the method further comprising:
generating a plurality of instructions to perform replication operations based on the a plurality of public file system objects, wherein the a plurality of instructions do not include file system operations that replicate individual file system objects of the a plurality of private file system objects; and
mirroring the public metadata file by transmitting the plurality of instructions to a destination storage server.

4. The method of claim 1, further comprising:
generating a volume information structure on the network storage server;
storing a reference to the private metadata file in the volume information structure; and
storing a reference to the public metadata file in the volume information structure.

5. The method of claim 1, wherein the first metadata container includes a metadata container identifier that is determined based on a predefined mapping.

6. The method of claim 1, further comprising:
generating a third file system object for storing application metadata; and
storing a third metadata container corresponding to the third file system object in the public metadata file.

7. The method of claim 1, wherein the source storage server has an operating system different from the operating system of the network storage server, the method further comprising:
receiving information from the source storage server specifying a root metadata container location; and
storing the root metadata container location in a volume information structure on the network storage server.

8. The method of claim 1, further comprising providing information relating to metadata containers in the public metadata file to a client of the network storage server and hiding information relating to metadata containers in the public metadata file from the client.

9. A network storage server comprising:
a storage component configured to store data for a file system on the network storage server, wherein the file system includes a logical volume;
a memory;
a processor coupled to the memory and the storage component;
a first inode container configured to store metadata associated with a first set of one or more file system objects in the logical volume; and
a second inode container configured to store metadata associated with a second set of one or more file system objects in the logical volume.

10. The network storage server of claim 9, further comprising:
a network interface configured to receive replication data defining one or more file system objects; and
a destination replication component configured to generate inodes for each of the one or more file system objects and to store each generated inode in the second inode container.

11. The network storage server of claim 9, further comprising:
a volume information structure on the network storage server, wherein the volume information structure includes a reference to the first inode container and a reference to the second inode container.

12. The network storage server of claim 9, further comprising:
a volume information structure on the network storage server, wherein the volume information structure includes a reference to the first inode container in the volume information structure and the first inode container includes a reference to the second inode container.

13. The network storage server of claim 9, wherein the first inode container includes a first inode that has an inode identifier determined based on a predefined mapping.

14. The network storage server of claim 9, wherein the first inode container includes a first inode having metadata defining a file system relationship with a second inode in the second inode container.

15. The network storage server of claim 9, further comprising:
a source replication component configured to generate a plurality of instructions to perform replication operations for replicating a portion of the contents of the network storage server, wherein the plurality of instructions are generated to replicate inodes contained in the second inode container and to not replicate inodes contained in the first inode container; and
a network interface configured to transmit the plurality of instructions to a destination storage server.

16. The network storage server of claim 9, further comprising:
a network interface component configured to receive a plurality of instructions to perform replication operations from a source storage server, wherein an individual instruction of the plurality instructions to perform replication operations includes information defining an inode creation operation, the information including a source inode identifier; and
a destination replication component configured to create a replicated inode based on the information, wherein the replicated inode has an inode identifier based on the source inode identifier and to store the replicated inode in the second inode container.

17. The network storage server of claim 9, wherein information relating to inodes in the second inode container is visible to a client of the network storage server and information relating to inodes in the first inode container is hidden from the client.

18. A method comprising:
maintaining a first inode container and a second inode container in a logical volume of a network storage server;
using the first inode container to store metadata of system files of the logical volume; and
using the second inode container to store metadata of user data files of the logical volume.

19. The method of claim 18, further comprising:
receiving replication data defining one or more file system objects;
generating inodes for each of the one or more file system objects in the logical volume; and
storing the generated inodes in the second inode container.

20. The method of claim 18, further comprising:
creating a volume information structure in the logical volume of the network storage server;
storing a reference to the first inode container in the volume information structure; and
storing a reference to the second inode container in the volume information structure.

21. The method of claim 18, further comprising:
creating a volume information structure on the network storage server;
storing a reference to the first inode container in the volume information structure; and
storing a reference to the second inode container in the first inode container.

22. The method of claim 18, further comprising assigning the first inode an inode identifier determined based on a predefined mapping.

23. The method of claim 18, further comprising:
generating a plurality of instructions to perform replication operations for replicating a portion of the contents of the network storage server, wherein the plurality of instructions are generated to replicate inodes contained in the second inode container and do not replicate inodes contained in the first inode container; and
transmitting the plurality of instructions to a destination storage server.

24. The method of claim 18, further comprising:
receiving a plurality of instructions to perform replication operations from a source storage server, wherein an individual instruction of the plurality of instructions to perform replication operations includes information defining an inode creation operation, the information including a source inode identifier;
creating a replicated inode based on the information, wherein the replicated inode has an inode identifier that is the same as the source inode identifier; and
storing the replicated inode in the second inode container.

25. The method of claim 18, further comprising storing an inode corresponding to an access control list (ACL) in the second inode container.

26. The method of claim 18, further comprising storing a root inode location in a volume information structure on the network storage server.

27. The method of claim 18, further comprising providing information relating to an inode in the second inode container to a client of the network storage server and hiding information relating to inodes in the first inode container from the client.

28. A system for replicating metadata comprising:
a storage interface configured to communicate with a storage component to store a logical volume;
a private metadata file configured to store metadata of system files of the logical volume;
a public metadata file configured to store metadata of user files of the logical volume;
a memory;
a processor coupled to the memory and the storage interface; and
a destination replication component configured to generate a metadata container for a user file based on an instruction to perform a replication operation received from a source storage server and to store the metadata container in the public metadata file.

29. The system of claim 28, wherein the metadata container is a first metadata container and further comprising a volume interface component configured to generate a second metadata container for a system file and to store the second metadata container in the private metadata container file.

30. The system of claim 28, further comprising a volume information block configured to store a reference to the private metadata file and a reference to the public metadata file.

31. The system of claim 28, further comprising a source replication component configured to generate a plurality of instructions to perform replication operations based on the metadata stored in the public metadata file and to transmit the plurality of instructions to a destination storage server.

32. The system of claim 28, wherein the instruction to perform the replication operation includes a target metadata container identifier and wherein the generated metadata container is stored in the public metadata file at a location corresponding to the target metadata container identifier.
